(19) United States
(12) Patent Application Publication
(10) Pub. No.: US 2007/0254511 A1
(43) Pub. Date: Nov. 1, 2007

(54) ADAPTER AND ELECTRONIC DEVICE USING THE SAME

(75) Inventors: Zhi-Kai Chen, Taipei (TW); Te-Chuan Kuo, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/739,698

(22) Filed: Apr. 25, 2007

(30) Foreign Application Priority Data
Apr. 26, 2006 (TW) 95114845

(51) Int. Cl. H01R 4/60

(52) U.S. Cl. 439/191

(57) ABSTRACT

An electronic device comprising a circuit board, a first connector, at least a signal wire and an adapter is provided. The first connector is disposed on the circuit board. The signal wire has a second connector. The adapter is used for connecting the first and the second connectors. The adapter includes a base and multiple guiding signs. The base has a first connecting portion and a second connecting portion. The first connecting portion is suitable for connecting with the first connector while the second connecting portion is suitable for connecting with the second connector. In addition, the guiding signs are located on the surface of the base. The electronic device is easy for assembly through the adapter.

### CROSS-REFERENCE TO RELATED APPLICATION

This application claims the priority benefit of Taiwan application serial no. 95114845, filed Apr. 26, 2006. All disclosure of the Taiwan application is incorporated herein by reference.

### BACKGROUND OF THE INVENTION

1. Field of the Invention

The present invention relates to an adapter, and more particularly, to an adapter that facilitates the connection of a signal wire to a circuit board and an electronic device that uses this adapter.

2. Description of Related Art

With the proliferation of computers, desktop computers are used not only in offices but also at home for surfing the net or processing data. A desktop computer mainly includes a display, a main console and some peripheral devices. Peripheral devices are mouse, keyboard, printer, speaker, scanner, digital camera and so on. The main console performs data computation and storage, and signals are output to the display or output or input via the peripheral device. In addition, the peripheral devices can be connected to the input/output ports respectively on the casing of the main console through signal wires thereof, so that the peripheral devices are electrically connected to the main circuit board of the main console via other signal wires inside the casing.

Beside providing input/output ports for the peripheral devices, the front panel of the main console casing may also include switches and light indicators connected to the main circuit board of the main console through signal wires inside the casing. Using the signal wires to the front panel of the main console casing, for example, the signal wires of power indicator light, hard drive operation indicator light and audio source, one end of each of these signal wires for connecting to the main circuit board is mostly an independent pin head connector. These pin head connectors are separately inserted into the corresponding pins of a multi-pin connector on the main circuit board.

Because the rack pins of a multi-pin connector on a main circuit board are narrowly spaced, it is difficult for a user to manually position the pin head connector of a signal wire accurately to the multi-pin connector. Although some of the multi-pin connectors are color-coded to distinguish the rack pins of particular types of signals, the casing will block out most external light when the main circuit board is installed inside the casing. This renders the user difficult to clearly identify the signal type and location of the rack pins protruding from the multi-pin connector on the main circuit board. Thus, it is rather difficult to manually connect the pin head connector to the multi-pin connector.

### SUMMARY OF THE INVENTION

Accordingly, at least one objective of the present invention is to provide an adapter such that connectors of signal wires can be conveniently assembled to a connector on a circuit board.

At least another objective of the present invention is to provide an electronic device whose adapter provides a convenient means of assembling connectors of signal wires to a connector on a circuit board.

To achieve these and other advantages and in accordance with the purpose of the invention, as embodied and broadly described herein, the invention provides an adapter. The adapter is suitable for connecting a first connector disposed on a circuit board to a second connector. The adapter includes a base and multiple guiding signs. The base has a first connecting portion and a second connecting portion. The first connecting portion is suitable for connecting with the first connector while the second connecting portion is suitable for connecting with the second connector. In addition, the guiding signs are located on the surface of the base.

In one embodiment of the present invention, the base has a first side, a second side and a third side. The first connection portion is located on the first side, the second connecting portion is located on the second side, and the third side connects the first side and the second side. The guiding signs are located on the surface of the third side.

In one embodiment of the present invention, the adapter further includes a plurality of conductive terminals. Each of the conductive terminals has a first end and a second end, and the first end is located in the first connecting portion and the second end is located in the second connecting portion.

In one embodiment of the present invention, the first connecting portion is a male connector and the second connecting portion is a female connector.

To achieve the foregoing advantages and in accordance with other purposes, the present invention also provides an electronic device comprising a circuit board, a first connector, at least a signal wire and an adapter. The first connector is disposed on the circuit board. The signal wire has a second connector. The adapter is used for connecting the first and the second connectors. The adapter includes a base and multiple guiding signs. The base has a first connecting portion and a second connecting portion. The first connecting portion is suitable for connecting with the first connector while the second connecting portion is suitable for connecting with the second connector. In addition, the guiding signs are located on the surface of the base.

In one embodiment of the present invention, the base of the adapter has a first side, a second side and a third side. The first connecting portion is located on the first side, the second connecting portion is located on the second side, and the third side connects the first side and the second side. The guiding signs are located on the surface of the third side.

In one embodiment of the present invention, the adapter further includes a plurality of conductive terminals. Each of the conductive terminals has a first end and a second end, and the first end is located in the first connecting portion and the second end is located in the second connecting portion.

In one embodiment of the present invention, the first connecting portion is a male connector and the second connecting portion is a female connector.

In one embodiment of the present invention, the signal wire is a signal wire for an indicator light or a signal wire for a switch.

Accordingly, the adapter in the present invention has guiding signs that allow a user to identify and easily assemble connectors of signal wires to the adapter, and then assemble the adapter to the connector on the circuit board. Hence, the signal wires are indirectly connected to the connector on the circuit board through the adapter. Therefore, the electronic device having this adapter is easier for assembly.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an explosion view showing the components of an electronic device according to one embodiment of the present invention.

FIG. 2 is a perspective view of the electronic device when the components shown in FIG. 1 are assembled.

FIG. 3 is a perspective view of the adapter shown in FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

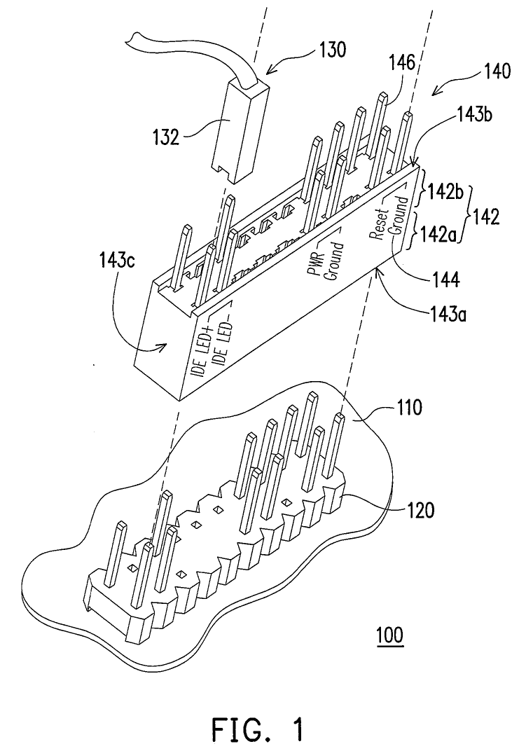

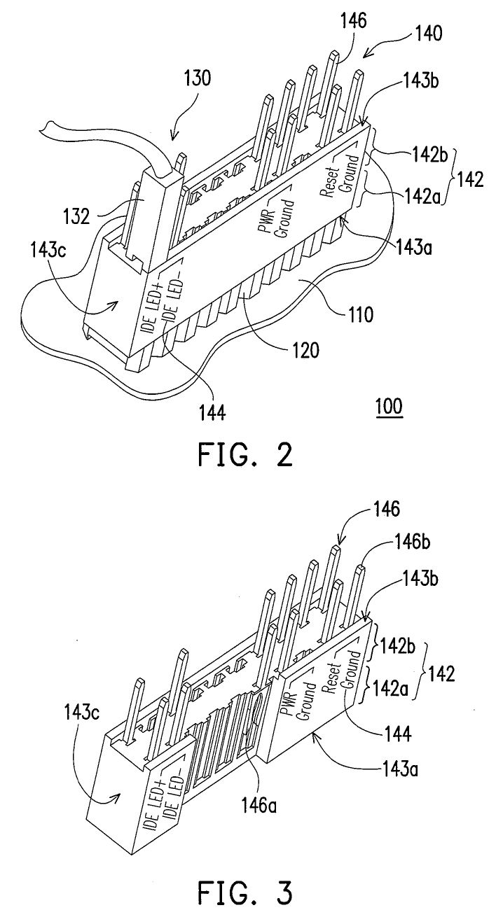

FIG. 1 is an explosion view showing the components of an electronic device according to one embodiment of the present invention. FIG. 2 is a perspective view of the electronic device when the components shown in FIG. 1 are assembled. As shown in FIGS. 1 and 2, the electronic device 100 in the present embodiment can be applied to form a connection between the main circuit board and the signal wires of a desktop computer. However, the scope of this invention is not limited in this way. The electronic device 100 includes a circuit board 110, a first connector 120, at least a signal wire 130 and an adapter 140. The first connector 120 is disposed on the circuit board 110. The first connector 120 can be a connector with rack pins or a male connector. In the present embodiment, a connector with rack pins is chosen as an example of the first connector 120 in the following illustration.

The signal wire 130 has a second connector 132. Furthermore, the second connector 132 in the present embodiment is a connector or a female connector capable of accommodating the rack pins on the first connector 120. In the present embodiment, the second connector 132 is chosen to be a connector capable of accommodating the rack pins on the first connector 120. The aforementioned signal wire 130 can be the signal wire for an indicator light, the signal wire for a switch, the signal wire for an audio source or even the signal wire for an expansion port (for example, USB and IEEE 1394).

The adapter 140 includes a base 142 having a first connecting portion 142a and a second connecting portion 142b. The first connecting portion 142a is suitable for assembling to and connecting with the first connector 120, while the second connecting portion 142b is suitable for assembling to and connecting with the second connector 132. Therefore, the second connector 132 of the signal wire 130 is able to assemble to the first connector 120 via the adapter 140 so that the signal wire 130 can electrically connect to the circuit board 110.

In the present embodiment, the first connector 120 is a pin-rack connector. Hence, the first connecting portion 142a of the adapter 140 can be a set of slots capable of accommodating the rack of pins on the first connector 120. In addition, the second connector 132 can be a connector capable of accommodating racks of pins. Therefore, the second connecting portion 142b of the adapter 140 is a connecting portion with racks of pins. Obviously, the present invention sets no limits to the type of the first connecting portion 142a, the second connecting portion 142b, the first connector 120 and the second connector 132. The only criterion is that the first connecting portion 142a must correspond to the first connector 120 and the second connecting portion 142b must correspond to the second connector 132. Here, ‘correspond’ means that the connecting portion and the connector are able to engage with each other and accommodate inside each other.

To help the user identify the signal transmission type and location, the adapter 140 further includes multiple of guiding signs 144 on the surface of the base 142. These guiding signs 144 are, for example, texts or patterns or a combination of the two. Moreover, these guiding signs 144 can either be printed on the surface of the base 142 or embossed to the surface of the base 142.

More specifically, the base 142 has a first side 143a, a second side 143b and a third side 143c. The first connecting portion 142a is located on the first side 143a, the second connecting portion 142b is located on the second side 143b, and the third side 143c connects the first side 143a and the second side 143b together. In the present embodiment, these guiding signs 144 are located on the third side 143c of the base 142. Therefore, the user can easily identify these guiding signs 144 and assemble the second connector 132 of the signal wire 130 to the second connecting portion 142 of the adapter 140 accordingly.

To prevent the adapter 140 from erroneously assembled to the first connector 120, a foolproof design may be added to the first connecting portion 142a of the adapter 140 and the first connector 120. For example, a non-symmetrical disposition of the rack pins or the filling of slots having no rack pins or other non-symmetrical design of structural forms may be deployed.

FIG. 3 is a perspective view of the adapter shown in FIG. 1. To provide a better explanation on the internal structures of the adapter 140, some of the internal components of the adapter 140 are exposed in FIG. 3. As shown in FIGS. 1 and 3, the adapter 140 further includes a plurality of conductive terminals 146. Each of the conductive terminals 146 has a first end 146a and a second end 146b. The first end 146a is located in the first connecting portion 142a, while the second end 146b is located in the second connecting portion 142b.

In the present embodiment, because the first connector 120 is a connector with rack pins as shown in FIGS. 1 and 3, the second connecting portion 142 of the adapter 140 is a receiving portion that corresponds to the rack pins. In other words, the conductive terminals 146 of the adapter 140 extend from the second side 143b of the second connecting portion 142b. In addition, because the first connector 120 is a connector with rack pins, the first connecting portion 142a of the adapter 140 is a connecting portion capable of accommodating rack pins. Therefore, the first ends 146a of the conductive terminals 146 of the adapter 140 are hidden inside the first connecting portion 142a.

In the present embodiment, when the signal wire 130 is electrically connected to the circuit board 110 through the second connector 132, the adapter 140 and the first connector 120, and when the first connector 120 is plugged into the first connecting portion 142a, the first connector 120 is electrically connected to the first end 146a of the conductive terminal 146 and the second end 146b of the conductive terminal 146 is electrically connected to the second connector 132. Thus, the signal wire 130 is electrically connected to the circuit board 110 via the adapter 140.

When the user needs to connect a plurality of signal wires 130 to the circuit board 110, the second connector 132 of the signal wires 130 can be pre-assembled to the second connecting portion 142b of the adapter 140 according to the guiding signs 144 on the adapter 140 first. After all the signal wires 130 are connected to the adapter 140, the first connecting portion 142a of the adapter 140 is assembled to the first connector 120 on the circuit board 110. Thus, after installing the circuit board 110 inside the computer casing (not shown), even if the casing blocks out external light and prevents a user from seeing the first connector 120, the user can still utilize the adapter 140 to connect the signal wires 130 to the circuit board 110.

In summary, the electronic device and adapter in the present invention allows a user to manually assemble a number of independent and randomly located signal wires onto the adapter before assembling the adapter to a connector on the circuit board. Hence, the signal wires are electrically connected to the circuit board. In addition, even if the casing blocks out external light and prevents the user from seeing the connector on the circuit board after installing the circuit board inside the casing, the pre-assembled signal wires on the adapter still allow the user an easy connection of the signal wires to the circuit board. Therefore, the adapter and the electronic device deploying the adapter in the present invention can significantly increase the easiness of assembling and electrically connecting the signal wires to the circuit board.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An adapter suitable for connecting a first connector disposed on a circuit board to a second connector, the adapter comprising:
a base having a first connecting portion and a second connecting portion, wherein the first connecting portion is suitable for connecting with the first connector while the second connecting portion is suitable for connecting with the second connector; and
a plurality of guiding signs located on a surface of the base.

2. The adapter of claim 1, wherein the base has a first side, a second side and a third side such that the first connecting portion is located on the first side, the second connecting portion is located on the second side, the first side and the second side are connected through the third side and the guiding signs are located on the surface of the third side.

3. The adapter of claim 1 further comprises a plurality of conductive terminals with each of the conductive terminals having a first end and a second end such that the first end is located in the first connecting portion while the second end is located in the second connecting portion.

4. The adapter of claim 1, wherein the first connecting portion is a male connector and the second connecting portion is a female connector.

5. An electronic device, comprising:
a circuit board;
a first connector, disposed on the circuit board;
at least a signal wire, wherein one end of the signal wire has a second connector;
an adapter for connecting the first connector to the second connector, the adapter having:
a base having a first connecting portion and a second connecting portion, wherein the first connecting portion is suitable for connecting with the first connector while the second connecting portion is suitable for connecting with the second connector; and
a plurality of guiding signs located on a surface of the base.

6. The electronic device of claim 5, wherein the base has a first side, a second side and a third side such that the first connecting portion is located on the first side, the second connecting portion is located on the second side, the first side and the second side are connected through the third side and the guiding signs are located on the surface of the third side.

7. The electronic device of claim 5, the adapter further comprises a plurality of conductive terminals with each of the conductive terminals having a first end and a second end such that the first end is located in the first connecting portion while the second end is located in the second connecting portion.

8. The electronic device of claim 5, wherein the first connecting portion is a male connector and the second connecting portion is a female connector.

9. The electronic device of claim 5, wherein the signal wire is a signal wire for an indicator light or a signal wire for a switch.
